(19) United States
(12) Patent Application Publication
(10) Pub. No.: US 2003/0021920 A1
(43) Pub. Date: Jan. 30, 2003

(54) Container forming method and product

(76) Inventors: James T. Williamson, Urbana, OH (US); Timothy A. VerVaecke, New Baltimore, MI (US)

Correspondence Address: BRINKS HOFER GILSON & LIONE, ONE INDIANA SQUARE, SUITE 1600, INDIANAPOLIS, IN, 46204-2033, US

(21) Appl. No.: 10/203,175

(22) PCT Filed:
(86) PCT No.: PCT/US01/44103

(51) Int. Cl. B32B 1/02

(52) U.S. Cl. 428/34.1

(57) ABSTRACT

A method and apparatus for connecting a metal lid to a metal body of a container to seal any product held by the container. The container is formed from a generally cylindrical metal body having an upper edge and a metal lid having a peripheral edge. The metal lid is held in position on the metal body so that the upper edge portion of the metal body and the peripheral edge of the metal lid form a contiguous junction. A beam of laser energy is directed toward the contiguous junction for sufficient time to hermetically seal the lid to the body. A single roll-formed lip provides a smooth finish to the combined body and lid. The lid includes a circumferentially continuous recess surrounding a central planar portion of the lid. The recess is located adjacent the peripheral edge while the peripheral edge is situated at or below the plane defined by the central planar portion, thereby reducing the material required to form a sealed container of any given volume.

### FIELD OF THE INVENTION

This invention relates generally to metal containers and more particularly to methods and apparatus for forming metal containers.

### BACKGROUND OF THE INVENTION

Metal containers, such as those used to contain beverages, including soda pop, beer and the like, are well known. Such containers, commonly known as cans, comprise a generally cylindrical body open at one end with a lid enclosing the open end and mechanically connected to the body. As shown in FIG. 1, conventional beverage cans 1 utilize a roll formed connection 2 between the lid 3 and the body 4 of the can. The roll form interconnection 2 between the lid 3 and body actually comprises two rolls of adjacent edges of the lid and body. A first edge 5 of the lid 3 is rolled outwardly over an upper edge portion 6 of the body 4 and thereafter the edges 5 and 6 are rolled together outwardly over the body 4 to provide five layers of material in the roll formed region as shown. The double roll form 2 requires the can to be passed through a plurality of workstations on chassis and around carousels where the can is “rolled” by a plurality roll form tools that increasingly effect the various stages of the roll form between the lid 3 and can body 4. This complex tooling is costly to install and maintain, thus contributing to the cost of manufacture of the cans.

While generally effective at connecting the lid to the body, the double roll form connection of conventional beverage containers utilizes a significant amount of material in the area of the roll formed connection, and also requires specific structures on the lid and body. The specific structures required include a recess in the lid providing a significant sidewall and engagement area for a mandrel, which engages and rotates the lid and the can body.

Further, while such mechanical roll forming is generally effective at connecting the lid 3 to the body 4, it does not provide a hermetic seal for the container. To provide a hermetic seal, an annular vinyl seal (labeled “A” in FIG. 1) must be disposed between the lid and the body in the area of the roll formed connection and prior to connecting the lid to the body. The vinyl seal increases the cost and difficulty of assembling a can and also requires additional machinery to locate and assemble the vinyl seal into the can.

Containers such as beverage cans and the like are processed in high volume at high speeds. The cans are filled with a beverage prior to connecting the lid to the body. The connection between the lid and body is mechanically provided at successive roll forming stations. The quality of individual roll form connections is not monitored, but rather, samples are tested downstream of all the roll-forming stations. When a defect is detected in the sample, there is no way to determine if the defect is an isolated incident or if the entire lot from which the sample was picked is defective. Accordingly, the entire lot and any additional inspected cans and/or lots of cans are rejected. Thus with each detected defect, a large volume of beverage product is wasted, and the output of filled cans is reduced thereby decreasing the efficiency and increasing the cost of the container forming and filling process.

There is therefore a need for container forming and sealing processes and equipment that can produce filled cans at a rate at least comparable to current manufacturing practices with increased reliability, use of less materials, and with tools and equipment that are less costly to install and maintain.

### SUMMARY OF THE INVENTION

A metal container in accordance with the present invention has a lid laser welded to an open end of a body of the container to join the lid to the body and to provide a hermetic seal between them. Desirably, the lid is placed directly on the container body, welded thereto and thereafter a single roll form occurs to reduce or eliminate any sharp edges and provide a smooth rim of the container. Far less material is required in the area of the lid and body connection of the present invention compared to conventional beverage containers having a double roll formed connection between the lid and the body. Further, laser welding the lid to the body provides a hermetic seal without the presence of any vinyl seal between the lid and body. Accordingly, the cost of the vinyl seal and the equipment needed to assemble the seal between the lid and body is eliminated.

Still further, an apparatus in accordance with the present invention to laser weld the lid to the body can be flexibly designed and can be adapted for use with conventional chassis and carousels that transport the containers between various roll forming workstations, or can process the cans in-line as they are carried downstream from a filling station by one or more conveyors. Therefore, the invention contemplates, without limitation, a container having an improved connection between a body and lid, and methods and apparatus for forming the improved container.

Objects, features and advantages of this invention include: providing a container having a body portion which can be formed of less material compared to conventional containers, a lid which can be formed of less material compared to conventional container lids, and a container having a hermetic seal between the lid and body without any separate polymeric seal material between them. The invention provides an improved connection between the lid and body, reduces the roll forming needed to connect the lid to the body, simplifies the seam connection between the lid and body, is of relatively simple design, and is economical to manufacture and assemble. A container of the present invention can be formed by a relatively simple method with apparatus that can connect the lid to the body in line or utilizing existing carousel structures used in conventional roll form applications for connecting the lid to the body.

The invention can accommodate a plurality of seam connection designs between the lid and the body as needed for a particular application. The container forming method of the present invention is reliable, durable, permits real-time sensing of the quality of the connection between a lid and body, reduces rejected containers, reduces waste of product disposed in the containers, reduces down time of the assembly and filling line for the containers, can be automated, and can be readily adapted for use with conventional filling and beverage container assembly operations, although the process and apparatus is not limited to merely beverages. The methods and apparatus of the present invention can be used on filling lines for a wide variety of products including foods, chemicals, paints, cosmetics, automotive products, etc.

These and other objects, features and advantages of this invention will be apparent from the following detailed description of preferred embodiments exemplifying the best mode known by the inventors at the time of filing. The description makes reference to the accompanying drawings.

### BRIEF DESCRIPTION OF THE DRAWINGS

FIG. 1 is a fragmentary sectional view illustrating a double roll form connection between a lid and can body of a prior art container.

FIG. 2 is a fragmentary sectional view illustrating a container having a lid connected to a body of the container according to the present invention.

FIG. 3 is a fragmentary sectional view of a second embodiment of a container according to the invention having a modified connection between the lid and body.

FIG. 4 is a fragmentary sectional view of a third embodiment of a container according to the invention illustrating a lid and body of the container prior to being laser welded together.

FIG. 5 is a fragmentary sectional view of the container of FIG. 4 illustrating the lid and body after being laser welded together and roll formed to provide a smooth rim of the container.

FIG. 6 is a fragmentary sectional view of a fourth embodiment of a container according to the invention illustrating a lid and body of the container prior to being laser welded together.

FIG. 7 is fragmentary sectional view as in FIG. 6 illustrating the lid and body of the container after being laser welded and roll formed.

FIG. 8 is a diagrammatic view of an apparatus according to the invention to connect a lid to a body of a container.

FIG. 9 is a diagrammatic view of a modified apparatus according to the invention to connect a lid to a body of a container.

FIG. 10 is a diagrammatic view of an apparatus for connecting a lid to a body of a container utilizing two lasers per container.

FIG. 11 is a diagrammatic view of a laser welding system that employs moving mirrors to direct the laser beam toward the can lid and body joint of a can.

FIG. 12 is a sectional view of another laser welding system that employs a conical reflector to form a ring-shaped beam that can be applied simultaneously around the circumference of a lid and body joint of a can.

FIGS. 13A-13C are a comparison study of the prior art container shown in FIG. 1 with two containers embodying the present invention.

FIG. 14 is a sectional view of a laser welding system similar to that shown in FIG. 12 that employs a conical reflector to form a ring-shaped beam that can be simultaneously applied radially inwardly around the circumference a container.

### DESCRIPTION OF THE PREFERRED EMBODIMENTS

Referring in more detail to the drawings, FIG. 2 illustrates a metal container 10 having a generally cylindrical body 12 open at one end 14 and a lid 16 having an inner surface 15 and an outer surface 17, fixed to the body 12 and closing its open end 14. The body 12 of the container 10 has an upper edge portion 18, which is rolled over and onto the outer surface 17 of a peripheral edge 20 of the lid 16 to preliminarily connect them together. Thereafter, the edges 18 and 20 of the lid 16 and body 12, respectively, are irradiated by a laser beam to weld the lid 16 and body 12 together. Desirably, the weld is circumferentially continuous and provides a hermetic seal between the lid 16 and body 12. Such a container 10 is ideally suited for use to contain products such as soup, soda pop, beer and the like.

In more detail, the lid 16 is preferably a generally circular metal disk that is stamped or otherwise formed from a flat sheet. The lid 16 preferably has a generally planar central portion 22 surrounded by a circumferentially continuous channel or recess 24, which is formed inboard of the peripheral edge 20 of the lid 16. To locate the lid 16 and body 12, an annular mandrel can be disposed in the recess 24 of the lid 16. This arrangement can also be used to rotate the container relative to the laser beam and/or a roll forming tool.

The body 12 of the container 10 has a generally cylindrical sidewall 30, which is tapered or necked down toward an open end 14 and is preferably closed at its other end by an integral bottom wall (not shown). The body 12 can be formed, for example, by cutting a circular disk from a flat sheet of metal. Thereafter the disk is drawn into the generally cylindrical final shape in a manner well known in the art. Other can body forming techniques can be employed to for a body suitable for use in the present invention.

As noted, the connection between the lid 16 and the body 12 is accomplished by laser welding the lid and body together, and roll forming the edge. These operations can be completed in different orders. For example, the upper edge 18 of the body 12 can be first rolled over the peripheral edge 20 of the lid 16 with the laser weld provided after this roll forming operation. Alternatively, the lid 16 can be disposed on a shoulder portion 21 of the body 12, located inboard of the upper edge 18 of the body 12 as shown in FIG. 2. The peripheral edge 20 of the lid 16 can then be laser welded to this shoulder portion 21. Thereafter, the upper edge 18 of the body 12 can be rolled over the peripheral edge 20 of the lid 16.

Regardless of the specific steps taken, the laser welded and roll formed connection provides a circumferentially continuous weld seam connection between the lid 16 and body 12 that comprises only three layers of material. Accordingly, the amount of material at the point of connection between the lid 16 and body 12 is substantially reduced from that of a container utilizing a double roll form connection between its lid and body which results in five layers of material at the seam connection.

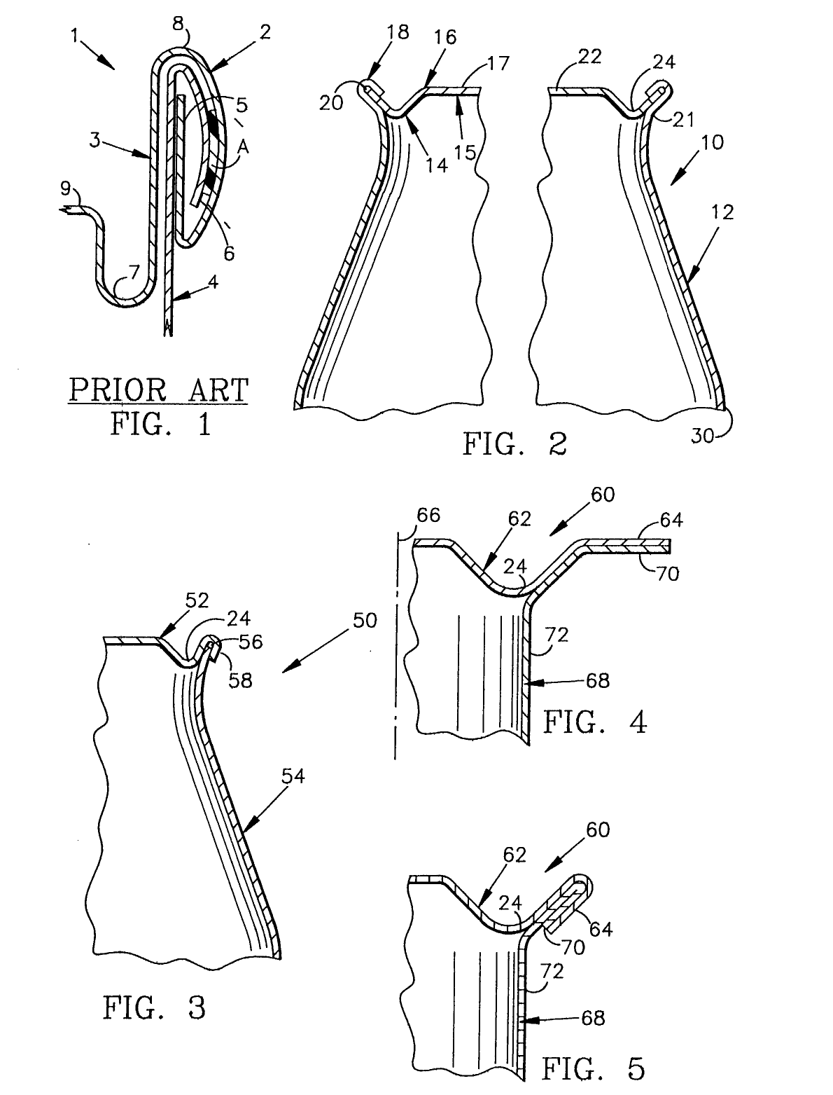

Beyond the material savings within the area of the seam connection, the lid can be designed to have a shorter or shallower recess 24 than is required in standard roll formed seam lids, further reducing the material required for the container 10 as a whole. For example, the axial height of the seam connection, as shown in FIG. 2 is substantially equal to the axial height of the central wall portion 22 of the lid 16. Notably, as shown in FIG. 1, prior art cans 1 utilizing a double roll form connection 2 have a deep recess 7 with the upper edge 8 of the seam connection 2 far above the central wall portion 9 of the lid 3. Such seam connection 2 is necessary for, among other reasons, to receive a mandrel which engages an axially inward facing surface of the lid 3 as it is moved from workstation to workstation to provide the double roll form, and to provide sufficient material for the double roll form. Further, with a shallower recess 24, and because less material is needed in the seam connection of the container 10, the sidewall 30 of the body 12 can be made shorter than is required for standard roll formed seam can bodies, further reducing the material of the container 10.

In one form, the container 10 is a beverage can with the lid 16 and body 12 formed from aluminum. To laser weld aluminum, intimate contact is needed between the components in the area of the laser weld. Accordingly, after the lid 16 is located on the body 12 a mandrel is preferably disposed on the lid 16 to provide a force pressing the peripheral edge 20 of the lid 16 onto the body 12 to firmly and intimately engage the lid 16 with the body 12 during laser welding. Alternatively, prior to laser welding, a single roll form connection can be provided between the lid 16 and body 12 to ensure their intimate engagement.

Preferably, pure argon is used as the shield gas for the laser welding process. Argon is a relatively heavy, inert shield gas that enables a smoother finished weld with less roughness or jagged edges in the weld seam or puddle area. Desirably, in the first embodiment of container 10, the weld can be made in the area of the recess of the lid. Accordingly, the relatively heavy argon shield gas can fill this area, to the extent not already filled by a mandrel, to provide an improved environment in the area of the weld during the welding process. This can further improve the quality and integrity of the weld.

Any suitable laser apparatus can be used, with currently preferred lasers being Nd:YAG and CO₂ lasers. However, laser technology is rapidly evolving and it is anticipated that the desired laser can change and improve over current lasers. One current laser which performs satisfactorily is a Nd:YAG laser, Model No. GSI/Lumonics AM 356, from GSI/Lumonics of Northville, Mich. This laser is rated at 4 kW, produces a continuous beam, uses a 600 micron fiber and has eight fiber output capability.

In conventional beverage can applications, a process speed of about 1500 cans per minute or greater is typical. In applications of the present invention in similar situations, the laser will likely be operated at between 500 watts and 2 kW, preferably between 750 watts and 1.2 kW. Such a laser apparatus provides a suitable weld of a typical beverage can having a lid formed of a non-ferrous material such as 5000 Series Aluminum about 0.008 in thick and a body formed of a non-ferrous material such as 3000 Series Aluminum about 0.006 in thick.

Further, the power output of the laser is preferably variable in proportion to the processing speed of the can filling and assembly line. If the line slows down, the power output of the laser should be reduced to prevent overheating, undue melting or cutting of the lids 16 or bodies 20. Likewise, if the speed of the line increases, the power output of the laser should be increased to ensure sufficient energy is applied to the cans that are more rapidly moving through the laser welding workstation.

To achieve higher processing rates, more than one laser can be used. For example, as shown in FIG. 10, two generally opposed lasers 32, 32′ can be used to simultaneously weld one can with each laser welding about 185° providing a slight overlap of the welds to ensure the seam weld is circumferentially continuous. As another alternative, two lasers can be used to separately and simultaneously weld two different cans. Of course, more than two lasers can be used.

A second embodiment of a container 50 according to the invention is shown in FIG. 3 and has a modified seam connection between its lid 52 and body 54. In this embodiment, the container 50 has a generally upright upper edge 56 over which a peripheral edge 58 of the lid 52 is rolled either before or after the lid 52 is laser welded to the body 54. The container 50 can be the same as container 10 in all other aspects. One advantage to this embodiment is that the peripheral edge 58 of the lid 52 is outside of the recess 24. Products in the container such as soup, soda pop or beer, can collect in the recess 24 when being dispensed from the container. Desirably, in this embodiment, there is no abrupt edge within the recess against which or under which product or contaminants can collect.

A third embodiment of a container 60 according to the invention is shown in FIG. 4. This container 60 has a lid 62 with a radially outer edge portion 64 outside of the recess 24 and extending generally perpendicular to a central axis 66 of the lid 62 and body 68. The body 68 has a corresponding upper edge portion 70 extending radially outwardly from the sidewall 72, generally perpendicular to the axis 66 of the lid 62 and body 68 and constructed and arranged to mate with the edge portion 64 of the lid 62. With the edge portions 64 and 70 of the lid 62 and body 68 respectively intimately engaged, a laser beam can be directed onto the interface between these edges 64 and 70 to weld the edges together. One or both of the container 60 and laser beam can be rotated to provide a circumferentially continuous weld. As shown in FIG. 5, after the laser weld is provided, the mated edges 64, 70 of both the lid 62 and body 68 can be rolled over toward the body 68 to provide a smooth rim of the container 60. Desirably, only a single roll form is needed and a hermetic seal is provided by the laser weld without any polymeric seal between the lid 62 and body 68.

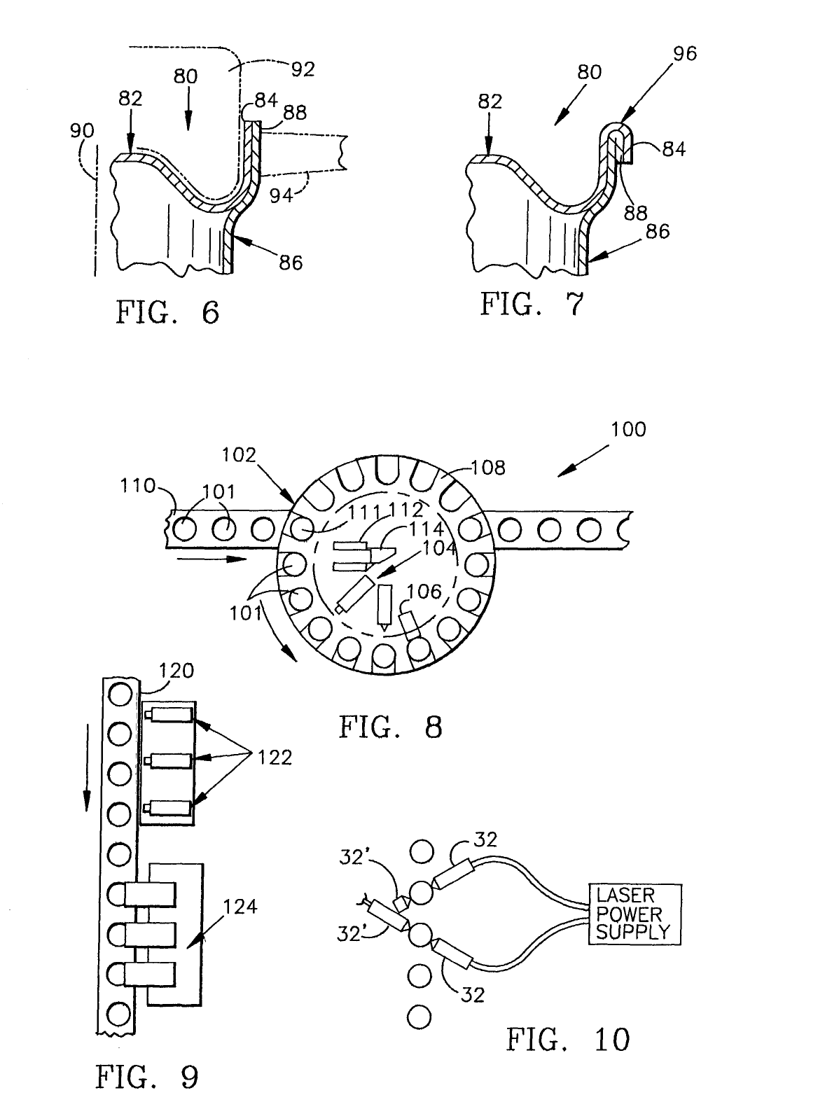

A fourth embodiment of a container 80 according to the invention is shown in FIG. 6 to have a lid 82 with a generally upright peripheral edge 84 and a body 86 with a corresponding and mating upright edge portion 88 welded to the edge 84 of the lid 82. The edges 84 and 88 of both the lid 82 and body 86 preferably extend generally parallel to the axis 90 of the lid 82 and body 86. To provide the intimate engagement between the edges 84 and 88 of the lid 82 and body 86 required for a satisfactory weld, the edges 84 and 88 must be clamped together such as by separate mandrels 92 and 94 located on opposed sides of the edges. Thereafter, the edges 84 and 88, and particularly an interface region of engagement between them, is irradiated with a laser beam to affect a weld between the lid 82 and body 86. After the weld is formed, the edges 84 and 88 can be rolled over outwardly and downwardly as shown in FIG. 7 onto the body 86 to provide a smooth rim 96 of the container 80 that resists becoming fouled or contaminated.

While the embodiments of FIG. 2 through 7 illustrate laser welding generally perpendicular to or parallel to a central axis of the lid and body of a container, it will be readily appreciated by those skilled in the art that these embodiments are merely illustrative of the broad aspects of the invention and other orientations of the lid, body and laser apparatus can be readily achieved to laser weld the lid and body in accordance with the present invention.

FIG. 8 illustrates an apparatus 100 which can be used to rapidly and reliably connect lids to corresponding bodies of a plurality of containers 101 in an assembly line arrangement. In one form, a conventional seam forming chassis 102 can be used with modifications to add the laser apparatus 104, the desired roll form tooling 106, and sensors and controls to ensure proper operation of the apparatus 100. The apparatus 100 can include a carousel 108 rotated at a speed corresponding to the speed of conveyors 110 upstream thereof such as by a variable speed motor. Containers 101 filled with product are provided to the carousel 108 one after another and are rotated with the rotating carousel 108 through various workstations to connect the lid to the body. As the containers 101 are transported by the carousel 108, they also rotate about their center lines or axes 111 in a known manner. Therefore, in given rotation of the carousel 108 each can transported by the carousel 108 will rotate a given distance relative about its axis 111.

To provide a circumferentially complete seal between a lid and body of a container, the laser apparatus 104 can be selectively engaged and rotated with the carousel 108. Desirably, the laser apparatus 104 can be rotated with the carousel 108 for a sufficient time to permit the container 101 to rotate one full revolution or slightly more about its central axis 111 to form a circumferentially complete weld. Thereafter, the laser apparatus 104 can backtrack to perform the weld of a lid and body of a subsequent container. In this manner, the laser apparatus 104 tracks with a particular container 101 until the container rotates at least one complete revolution about its axis 111 and then backtracks to the next consecutive container and so on.

To accomplish the tracking and back tracking operation, the laser apparatus 104 can be mounted on a plate 112 which is attached to a crankshaft 114 timed off the rotation of the carousel 108. The crankshaft 114 will permit the laser apparatus 104 to move through a specific and reciprocating path. The laser can also weld a subsequent can during its back track stroke or movement, although the back track movement will generally have to be at a slower speed because such movement is generally in the opposite direction of the movement of the cans.

Real time monitoring of the laser power output will be needed to control the laser output relative to the rotational and translational (component of movement along path of conveyor or carousel) speed of the containers 101 to ensure that quality welds are being made. Downstream of the laser weld, one or more conventional roll form tools 106 can be used to provide the single roll form of the laser welded seam to provide the generally smooth rim of the container. Of course, the position of the roll form and laser weld tools can be switched such that the roll forming occurs upstream of the laser weld, if desired.

It is also possible to provide the laser weld and any roll forming as the containers 101 are moved inline on a linear conveyor 120 as shown in FIG. 9, rather than via a carousel as described in connection with FIG. 8. Suitable mandrels or clamps engage the lids and bodies of the containers 101 and rotate individual containers 101 as they pass by a laser apparatus 122 and roll form apparatus 124 as needed. The laser apparatus 122 is moved in timed relationship with the conveyor 120 (such by a crankshaft driven off a drive wheel of the conveyor) to track with a container until the container is rotated at least one complete revolution about its central axis. Thereafter, the laser apparatus 122 can backtrack to the next consecutive container to be advanced along with that container and form the weld. Again, more than one laser can be used to weld each can, or to separately and simultaneously weld more than one can.

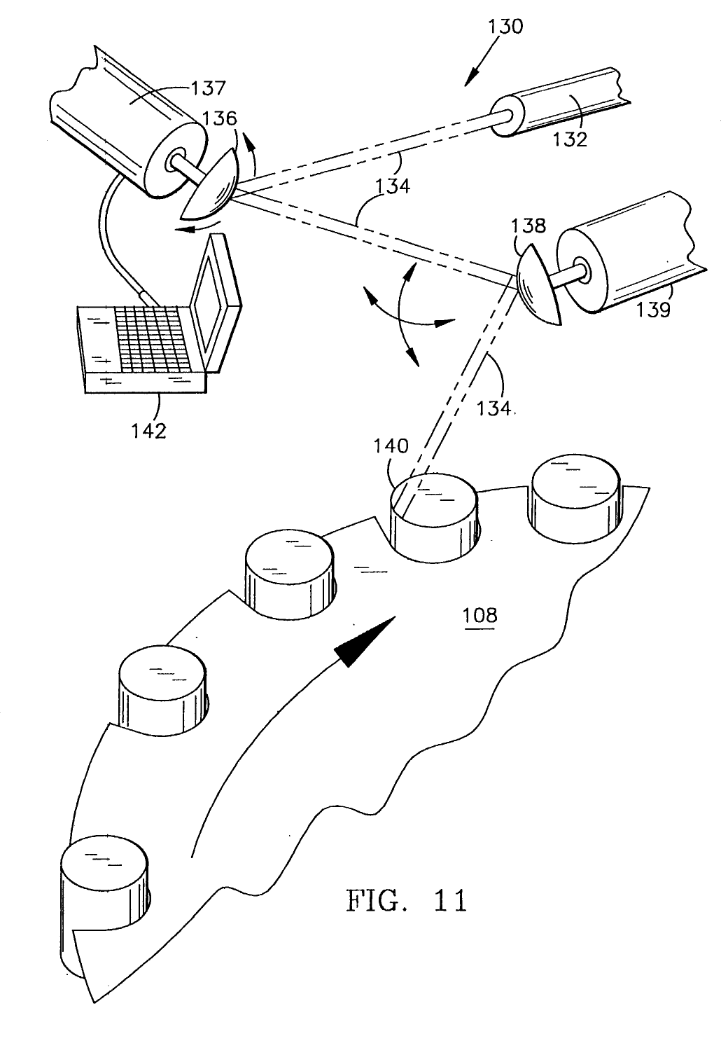

Another laser apparatus 130 is shown in FIG. 11, which is suitable for use in welding the lids and bodies of containers 101 together as they are transported around a carousel 108. All mandrels have been omitted from FIG. 11 to permit better visualization of the remaining portions of the apparatus. The laser 132 is situated at a fixed location conveniently positioned so that the beam 134 is directed toward a first mirror 136 and a second mirror 138. The mirrors 136 and 138 are independently movable in at least one and preferable two directions by gimbaled mirror mounts 137 and 139, respectively, so that the laser beam 134 can be variously directed. The exact location of the focal spot 140 of the laser beam 134 is controlled by signals generated by a controller, such as a p.c. 142, which is coupled to the mirror mounts 137 and 139. The focal spot 140 can be made to traverse the circumference of the joint region of the lid and body of each container as it is carried through a welding region by the carousel 108.

The linear welding speed of the focal spot 140 generated by the apparatus 130 can easily approach 250 m/min yet still achieve satisfactory welds using a low to moderate powered laser 132. If still higher speeds are desired, additional laser apparatus 130 can be positioned at a slightly different location around the circumference of the carousel 108, and additional sets of mirrors 136 and 138 provided and programmed so that welding is accomplished on every second or third can spaced around the carousel 108.

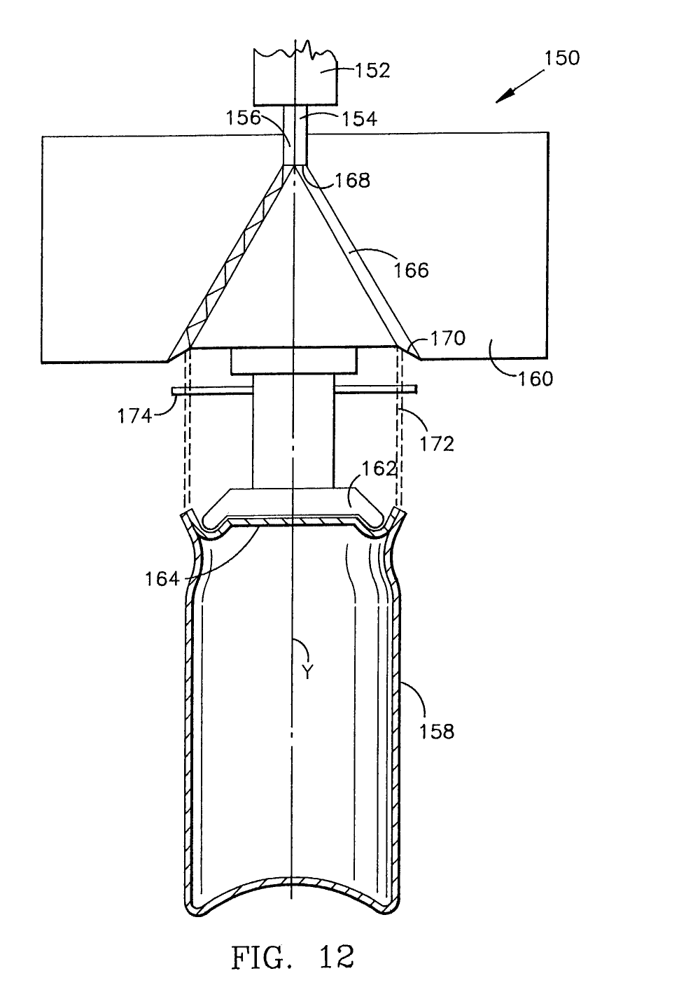

Another laser welding system 150 suitable for use in the present invention is shown in FIG. 12 to include a laser source 152, which can take the form of an optical fiber 154 having an end 156 that is positioned on and directed along the axis Y of a container body 158. A mandrel 160 includes a lid-carrying portion 162 for positioning a lid 164 on the container body 158. The mandrel 160 also includes a conical reflector or director portion 166 having an upper end 168 coupled to the laser source 152, and a lower end 170 forming a ring-shaped aperture for directing a ring-shaped beam 172 of laser power toward the joint between the body 158 and lid 164. The mandrel 160 can also carry one or more lenses 174 for focusing the ring-shaped beam.

An advantage of welding system 150 is the simultaneous application of the weld power around the complete periphery of the can and lid, thus reducing the opportunity for movement due to localized heating. If suitable power is available, the welding time may be shortened to just a “flash” or “snap shot”. It will be recognized by those skilled in the art that the conical reflector or director portion 166 acts to spread out the beam originally present in the source 152 or fiber end 156, thus reducing the beam power density. To achieve the necessary heating to achieve welding with the system 150, it will be necessary to employ higher-powered laser sources than in other embodiments. The fiber optic delivery of the power directly to the axis of the can being formed permits the adaptation of this system to a variety of line layouts.

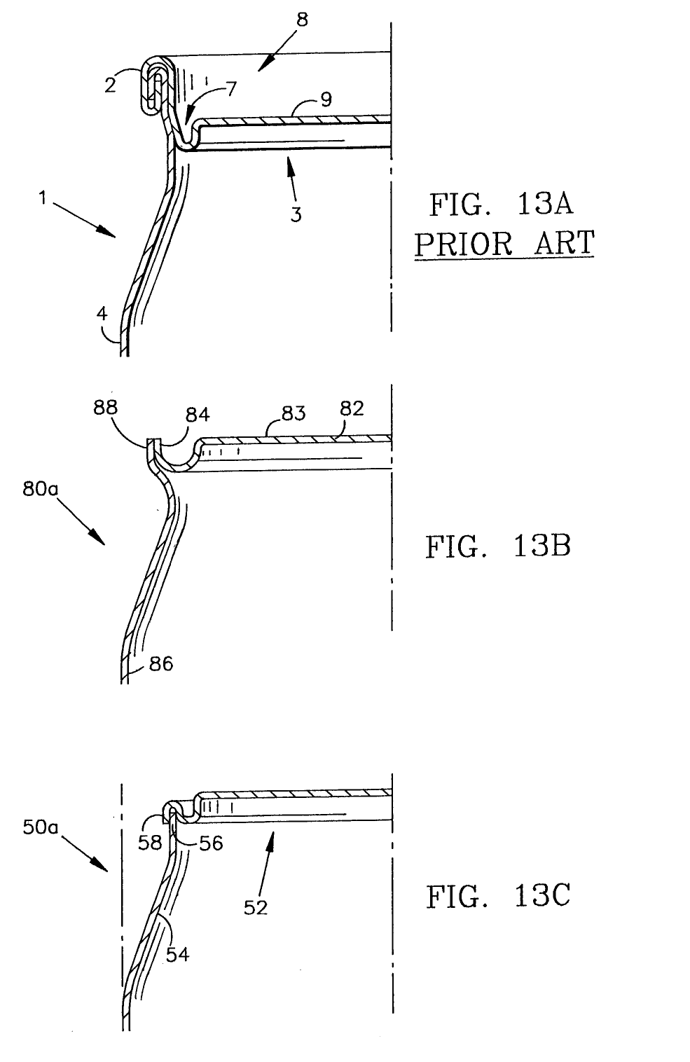

A comparison study of the prior art container 1 shown in FIG. 1 with two containers embodying the present invention is shown by the three views provided by FIGS. 13A through 13C. The prior art container 1 shown in FIG. 13A utilizes a roll formed connection 2 between the lid 3 and the body 4. A deep recess 7 separates the central wall portion 9 of the lid 3 from the upper edge 8 of the seam connection 2, which is located far above the central wall portion 9. A first container 80a is shown in FIG. 13B, which is similar to that shown in FIG. 6, and has a lid 82 with a central wall portion 83 and a generally upright peripheral edge 84. The container 80a also has a body 86 with a corresponding and mating upright edge portion 88. The weld of the edges 84 and 88 and be accomplished with a variety of systems including the system 150 shown in FIG. 12. The savings in material that is achieved by changing from the container 1 of FIG. 13A to container 80a of FIG. 13B can be seen by merely comparing the amount of metal that appears above the upper surface of the central wall portions 9 and 83 of the two containers.

Even additional savings in material can be achieved by adopting a container 50a shown in FIG. 13C that is similar to that shown in FIG. 3. The container 50a has a lid 52 and body 54. The body 54 has a generally upright upper edge 56 over which a peripheral edge 58 of the lid 52 is rolled either before or after the lid 52 is laser welded to the body 54. With the container 50a, the laser beam for achieving the weld must generally have some radially inward component to achieve the necessary heating at the correct location. While the laser welding systems shown in FIGS. 8-11 are suitable to accomplish this, the system 150 shown in FIG. 12 is not as desirable unless modified to have the radially inward component.

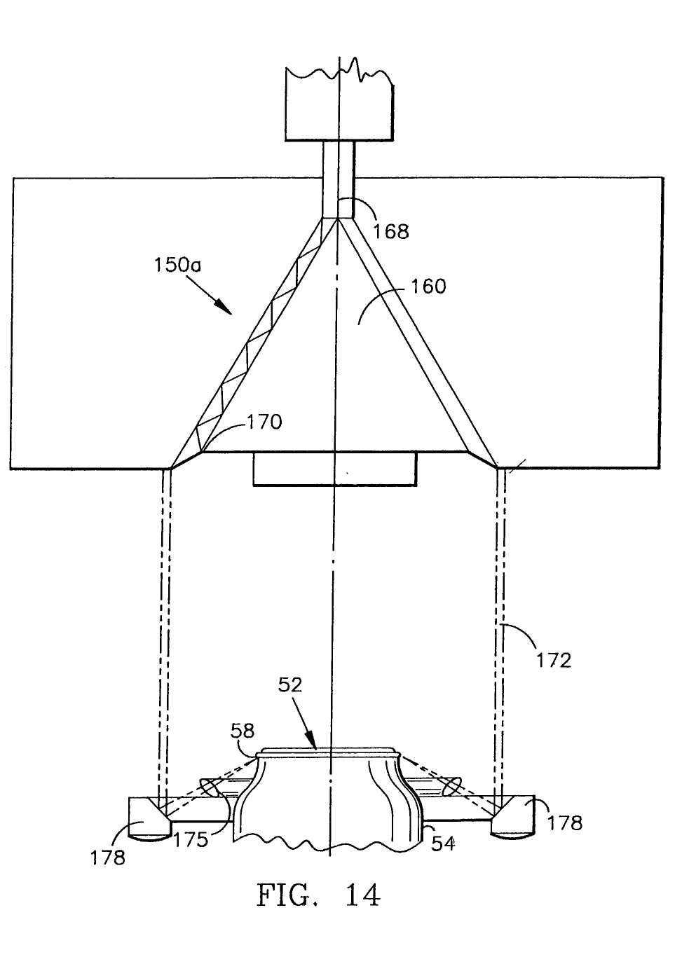

Such a modified system 150a is shown in FIG. 14. The system 150a includes a conical reflector or director portion 166 having an upper end 168 coupled to the laser source, and a lower end 170 forming a ring-shaped aperture that is similar to but somewhat larger than that shown in FIG. 12. A ring shaped mirror 178 is positioned to redirect the ring-shaped beam 172 of laser power toward the joint between the body 54 and lid 52. The ring shaped mirror 178 can be either fixed or movable relative to the conical reflector or director portion 166. One or more lenses 175 can be included for focusing the ring-shaped beam.

Desirably, any of the previously described apparatus can use a substantial portion of an already existing assembly line including a mechanism which places and locates the lids on the bodies and even some of the mandrels which currently engage the lid and body during the conventional double roll form seam connection between a lid and body. As described above, the apparatus can even use the rotating carousel of an existing seam forming apparatus and the various conveyors which transport the containers to and from the carousel. Desirably, the apparatus does not require any mechanism to place and locate a polymeric seal between the lid and body because such a seal is not needed due to the hermetic seal provided by the laser weld. Further, the rotating carousel can be removed and the laser weld can be formed in-line, if desired.

Accordingly, containers and methods and apparatus for forming the containers are provided by the present invention that significantly reduce the amount of material required to form the container, eliminates a separate polymeric seal needed in conventional containers, and eliminates at least some of the roll forming operations required to connect the lid to the body of the container. Desirably, controls and sensors can be provided to monitor the quality of weld of individual containers. Any unsatisfactory welds or containers can be individually removed from the assembly process thereby greatly reducing the number of rejected or scrapped containers and consequently greatly reducing the amount of product wasted. Still further, real time adjustments to the laser apparatus can automatically correct the laser output after a reject or problem is detected to reduce the number of containers that are defective and must be rejected. The laser welding can provide a fast, durable, reliable weld that has significant practical and economical advantages over the current container utilizing a double roll form connection between the lid and body.

Although the invention has been described in detail with reference to certain preferred embodiments, variations and modifications exist within the scope and spirit of the invention as described and defined in the following claims.

What is claimed is:

1. Apparatus for connecting a metal lid having a peripheral edge to a metal body of a container having an upper edge to seal any product held by the container, the apparatus comprising:
positioning means for positioning the metal lid on the metal body so that the upper edge portion of the metal body and the peripheral edge of the metal lid form a contiguous junction, laser means for generating a beam of laser energy, and directing means for directing the beam of laser energy on the contiguous junction for sufficient time to hermetically seal the lid to the body despite the absence of a double roll seam between the lid and body.

2. Apparatus for connecting a metal lid to a metal body of a container to seal any product held by the container, the apparatus comprising:
body forming means for forming an upper edge portion of the metal body, lid forming means for forming a peripheral edge of the metal lid, positioning means for positioning the metal lid on the metal body so that the upper edge portion of the metal body and the peripheral edge of the metal lid form a contiguous junction in the absence of a double roll seam, laser means for generating a beam of laser energy, and directing means for directing the beam of laser energy on the contiguous junction for sufficient time to hermetically seal the lid to the body despite the absence of a double roll seam between the lid and body.

3. The apparatus of claims 1 or 2 wherein the directing means includes a lens for focusing the beam of laser energy on the contiguous junction.

4. The apparatus of any of claims 1 to 3 wherein the directing means includes a mirror.

5. The apparatus of any of claims 1 to 4 wherein the directing means comprises a ring-shaped member.

6. The apparatus of claim 5 wherein the ring-shaped member is conical.

7. The apparatus of any of claims 1 to 6 wherein the directing means includes a fiber optic carrier for the laser energy.

8. The apparatus of claim 7 wherein the fiber optic carrier has one end aligned with an axis symmetry of the lid and body forming the container.

9. The apparatus of any of claims 1 to 4 wherein the laser means comprises mounting means for rotating the laser beam relative to the contiguous junction.

10. The apparatus of any of claims 1 to 9 wherein the laser means comprises a Nd:YAG or CO₂ laser capable of operating at a power of between 500 and 4000 Watts.

11. The apparatus of any of claims 1 to 10 wherein the laser means comprises a gas shielding means providing a flow of an inert gas toward the contiguous junction at least at the location of the laser beam.

12. The apparatus of any of claims 1 to 11 wherein the positioning means comprises a mandrel providing a downward force pressing the lid into intimate contact with the can body.

13. The apparatus of any of claims 1 to 12 wherein the positioning means includes forming means for forming a single roll form connection between the lid and the can body.

14. The apparatus of claim 13 wherein the forming means is situated to form the single roll in advance of the laser beam.

15. The apparatus of claim 13 wherein the forming means is situated to form the single roll following the laser beam.

16. The apparatus of any of claims 1 to 15 wherein the positioning means includes rotating means for rotating the can body and lid relative to the laser means.

17. The apparatus of claim 16 wherein the rotating means comprises a rotating carousel.

18. The apparatus of either claim 16 or 17 wherein the laser means includes carrier means movable in relation to the rotating can body to permit the laser to travel with the rotating can body and lid, and to permit the laser to back track to a location adjacent to a subsequent can body and lid.

19. A method for connecting a metal lid having a peripheral edge to a metal body of a container having an upper edge to seal any product held by the container, the method comprising the steps of:
positioning the metal lid on the metal body so that the upper edge portion of the metal body and the peripheral edge of the metal lid form a contiguous junction in the absence of a double roll seam,
generating a beam of laser energy, and
directing the beam of laser energy on the contiguous junction for sufficient time to hermetically seal the lid to the body despite the absence of a double roll seam between the lid and body.

20. A method for connecting a metal lid to a metal body of a container to seal any product held by the container, the method comprising the steps of:
forming an upper edge portion of the metal body,
forming a peripheral edge of the metal lid,
positioning the metal lid on the metal body so that the upper edge portion of the metal body and the peripheral edge of the metal lid form a contiguous junction in the absence of a double roll seam,
generating a beam of laser energy, and
directing the beam of laser energy on the contiguous junction for sufficient time to hermetically seal the lid to the body despite the absence of a double roll seam between the lid and body.

21. The method of claims 19 or 20 wherein the directing step includes the step of focusing the beam of laser energy on the contiguous junction.

22. The method of any of claims 19 to 21 wherein the directing step includes the step of providing a fiber optic carrier for the laser energy.

23. The method of claim 22 further comprising the step of aligning one end of the fiber optic carrier with an axis symmetry of the lid and body forming the container.

24. The method of any of claims 19 to 23 further comprising the step of rotating the laser beam relative to the contiguous junction.

25. The method of any of claims 19 to 24 further comprising the step of operating the laser at a power of between 500 and 4000 Watts.

26. The method of any of claims 19 to 25 further comprising the step of shielding the contiguous junction at least at the location of the laser beam with a flow of an inert gas.

27. The method of any of claims 19 to 26 further comprising the step of providing a downward force pressing the lid into intimate contact with the can body during said generating step.

28. The method of any of claims 19 to 27 further comprising the step of roll-forming only a single roll form connection between the lid and the can body.

29. The method of claim 28 wherein the single roll-forming step is performed in advance of said directing step.

30. The method of claim 28 wherein the single roll-forming step is performed subsequent to said directing step.

31. The method of any of claims 28 to 30 wherein the single roll-forming step is performed on a protruding portion of the lid so that it envelops the upper edge portion of the body.

32. The method of any of claims 28 to 30 wherein the single roll-forming step is performed on a protruding portion of the body so that it envelops the peripheral edge of the lid.

33. The method of any of claims 19 to 32 further comprising the step of rotating the can body and lid relative to the beam of laser energy.

34. The method of claim 33 further comprising the step of moving the beam of laser energy in relation to the rotating can body to permit travel with the rotating can body and lid, and to permit the back tracking to a location adjacent to a subsequent can body and lid.

35. The method of any of claims 20 to 34 wherein the step of forming said upper edge of the can body includes necking down an open end of the can body.

36. The method of any of claims 20 to 35 wherein the step of forming said upper edge of the can body includes forming an outward taper or flange at the open end of the can body.

37. The method of any of claims 20 to 36 wherein the step of forming the peripheral edge of the metal lid includes the step of forming a circumferentially continuous recess surrounding a central planar portion, the recess being adjacent the peripheral edge, the peripheral edge being situated at or below the plane defined by the central planar portion.

38. A container comprising: a generally cylindrical body having a closed lower end and an upper edge, a lid including a peripheral edge of the lid positioned so that the upper edge portion of the body and the peripheral edge of the metal lid form a contiguous junction, a continuous weld at the contiguous junction hermetically sealing the lid to the body, and a single roll-formed lip to provide a smooth finish to the combined body and lid despite the absence of a double roll seam between the lid and body.

39. The container of claim 38 further comprising a circumferentially continuous recess surrounding a central planar portion of the lid, the recess being adjacent the peripheral edge, the peripheral edge being situated at or below the plane defined by the central planar portion.

40. The container of either claim 38 or 39 further comprising a necked down portion adjacent the upper edge of the can body.

41. The container of any of claims 38 to 40 wherein said single roll-formed lip consists of a portion of the peripheral edge of the lid rolled over the upper edge of the body.

42. The container of any of claims 38 to 40 wherein said single roll-formed lip consists of a portion of the upper edge of the body rolled over the peripheral edge of the lid.
